(19) United States
(12) Patent Application Publication
(10) Pub. No.: US 2008/0181306 A1
(43) Pub. Date: Jul. 31, 2008

(54) METHOD AND APPARATUS FOR MOTION VECTOR ESTIMATION USING MOTION VECTORS OF NEIGHBORING IMAGE BLOCKS

(75) Inventors: Dae-hyun KIM, Suwon-si (KR); Seung-hoon HAN, Seoul (KR); Seung-joon YANG, Seoul (KR); Anna LEE, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/830,026

(22) Filed: Jul. 30, 2007

(30) Foreign Application Priority Data
Jan. 25, 2007 (KR) 10-2007-0007945

(51) Int. Cl. H04B 1/66

(52) U.S. Cl. 375/240.16

(57) ABSTRACT

A method and an apparatus for motion vector estimation using motion vectors of neighboring image blocks are provided. The method includes dividing a current image block into a plurality of sub-blocks; and estimating motion vectors of the sub-blocks using the motion vectors and pixel weights of the neighboring image blocks adjacent to the sub-blocks.

### CROSS-REFERENCE TO RELATED APPLICATION

This application claims priority from Korean Patent Application No. 10-2007-0007945, filed on Jan. 25, 2007 in the Korean Intellectual Property Office, the disclosure of which is incorporated herein in its entirety by reference.

### BACKGROUND OF THE INVENTION

1. Field of the Invention

The present invention relates to a method of estimating a motion vector, and more particularly, to a method and apparatus for motion vector estimation using motion vectors of neighboring image blocks.

2. Description of the Related Art

FIGS. 1A through 1C are views for describing a related art method of pixel-based motion vector estimation.

Referring to FIG. 1A, fifteen image blocks A through 0 are illustrated. Block-based motion vectors of image blocks A through 0 have already been estimated. However, in block-based motion vector estimation, rectangular edges are generated between the image blocks, thereby block artifacts occur.

In pixel-based motion estimation, block artifacts can be prevented. However, the pixel-based motion estimation requires excessively high costs to prepare hardware for the estimation. Thus, a method of pixel-based motion vector estimation using the block-based motion vectors is suggested.

Referring to FIG. 1B, block H is divided into four sub-blocks H1, H2, H3 and H4. In order to estimate a motion vector of the sub-block H1, motion vectors of blocks H, E and G in an x-direction are detected and then a median H1.x is obtained from the motion vectors of the blocks H, E and G in the x-direction. Motion vectors of the blocks H, E and G in a y-direction are detected and then a median H1.y is obtained from the motion vectors of the blocks H, E and G in the y-direction. A motion vector H1 is generated using the medians H1.x and H1.y.

If the motion vector H1 is equal to motion vectors E and G of the blocks H, E and G, the motion vector H1 is set as the motion vector of the sub-block H1. If the motion vector H1 is unequal to the motion vectors H, E, and G of the blocks H, E and G, the motion vector H of the block H is set as the motion vector of the sub-block H1. Likewise, motion vectors H2, H3 and H4 of the sub-blocks H2, H3 and H4 can be obtained using the above-described process.

The process of obtaining the motion vectors H1, H2, H3 and H4 can be represented by Equation 1.

H1.x=median(H.x,E.x,G.x)

H1.y=median(H.y,E.y,G.y)

If (H1<>H) and (H1<>E) and (H1<>G) then H1=H

H2.x=median(H.x,G.x,K.x)

H2.y=median(H.y,G.y,K.y)

If (H2<>H) and (H2<>G) and (H2<>K) then H2=H

H3.x=median(H.x,I.x,K.x)

H3.y=median(H.y,I.y,K.y)

If (H3<>H) and (H3<>I) and (H3<>K) then H3=H

H4.x=median(H.x,I.x,E.x)

H4.y=median(H.y,I.y,E.y)

If (H4<>H) and (H4<>I) and (H4<>E) then H4=H (1)

where ‘<>’means ‘is unequal to.’

After the motion vectors H1, H2, H3 and H4 are obtained by the process of Equation 1, pixel-based motion vectors can be obtained by repeating the process of Equation 1 on further divided sub-blocks.

Referring to FIG. 1C, the sub-block H1 is further divided into a plurality of sub-blocks H1a, H1b, H1c and H1d. A motion vector of the sub-block H1a can be obtained by equation 2. Specifically, the process of Equation 1 is performed on sub-blocks H1a,E2 and G4.

H1a.x=median(H1.x,E2.x,G4.x)

H1a.y=median(H1.y,E2.y,G4.y)

If (H1a<>H1) and (H1a<>E2)and (H1a<>G4) then H1a=H1 (2)

When the processes of Equations 1 and 2 are repeated on further divided sub-pixels, the pixel-based motion vectors can be ultimately estimated.

In the above-described related art method of estimating pixel-based motion vectors, motion vectors are estimated using a method of obtaining medians, which does not allow block artifacts to be efficiently removed.

### SUMMARY OF THE INVENTION

The present invention provides a method and apparatus for motion vector estimation using motion vectors of neighboring image blocks so that image blocks can be smoothly connected and block artifacts can be efficiently reduced by estimating pixel-based motion vectors.

According to an aspect of the present invention, there is provided a method of estimating a motion vector using motion vectors of neighboring image blocks, the method including dividing a current image block into a plurality of sub-blocks; and estimating motion vectors of the sub-blocks using the motion vectors and pixel weights of the neighboring image blocks adjacent to the sub-blocks.

The method may further include detecting a number of pixels of the current image block; and repeating the dividing of the current image block and the estimating of the motion vectors until pixel-based motion vectors of the current image block are estimated, based on the number of pixels.

The estimating the motion vectors may include selecting reference image blocks, whose motion vectors and weights are to be referred to, from among the neighboring image blocks; detecting the motion vectors and the weights of the reference image blocks; and estimating the motion vectors of the sub-blocks using the motion vectors and the weights of the reference image blocks.

The estimating the motion vectors may further include calculating pixel weights of the reference image blocks.

The detecting the weights of the reference image blocks may include detecting pixel weights of the reference image blocks from a lookup table in which the pixel weights are calculated and stored.

The detecting the motion vectors of the reference image blocks may include detecting motion vectors of the reference image blocks in an x-direction; and detecting motion vectors of the reference image blocks in a y-direction.

A number of the pixel weights of each of the neighboring image blocks may correspond to a number of pixels of each of the neighboring image blocks.

The pixel weights of the neighboring image blocks may be represented in a matrix, and a weight arrangement of the matrix may be determined based on positions of the neighboring image block and the current image block.

The estimating the motion vectors may include multiplying the motion vectors of the reference image blocks by the weights of the reference image blocks; multiplying the motion vectors of the current image block by pixel weights of the current image block; and summing the motion vectors of the reference image blocks multiplied by the weights of the reference image blocks and the motion vectors of the current image block multiplied by the pixel weights of the current image block.

The pixel weights of the current image block may be represented in a matrix, and a weight arrangement of the matrix may be one of a linear type and a non-linear type.

According to another aspect of the present invention, there is provided an apparatus for motion vector estimation using motion vectors of neighboring image blocks, the apparatus including a block division unit which divides a current image block into a plurality of sub-blocks; and a motion vector estimation unit which estimates motion vectors of the sub-blocks using the motion vectors and pixel weights of the neighboring image blocks adjacent to the sub-blocks.

The apparatus may further include a repetition unit which detects a number of pixels of the current image block, and repeats the dividing of the current image block and the estimating of the motion vectors until pixel-based motion vectors of the current image block are estimated, based on the number of pixels.

The motion vector estimation unit may include a reference block selection unit which selects reference image blocks, whose motion vectors and weights are to be referred to, from among the neighboring image blocks; a block information detection unit which detects the motion vectors and the weights of the reference image blocks; and an estimation unit which estimates the motion vectors of the sub-blocks using the motion vectors and the weights of the reference image blocks.

The motion vector estimation unit may further include a weight calculation unit which calculates pixel weights of the reference image blocks or of the current image block.

The estimation unit may include a multiplication unit which multiplies the motion vectors of the reference image blocks by the weights of the reference image blocks and multiplies the motion vectors of the current image block by pixel weights of the current image block; and an addition unit which sums the motion vectors of the reference image blocks multiplied by the weights of the reference image blocks and the motion vectors of the current image block multiplied by the pixel weights of the current image block.

According to another aspect of the present invention, there is provided a computer readable recording medium having recorded thereon a computer program for executing a method of estimating a motion vector using motion vectors of neighboring image blocks, the method including dividing a current image block into a plurality of sub-blocks; and estimating motion vectors of the sub-blocks using the motion vectors and pixel weights of the neighboring image blocks adjacent to the sub-blocks.

### BRIEF DESCRIPTION OF THE DRAWINGS

The above and other aspects of the present invention will become more apparent by describing in detail exemplary embodiments thereof with reference to the attached drawings in which:

FIGS. 1A through 1C are views for describing a related art method of pixel-based motion vector estimation;

FIG. 2 is a block diagram of an apparatus for motion vector estimation using motion vectors of neighboring image blocks, according to an exemplary embodiment of the present invention;

FIG. 3 is a block diagram of a motion vector estimation unit according to an exemplary embodiment of the present invention;

FIG. 4 is a view for describing reference image blocks according to an exemplary embodiment of the present invention;

FIG. 5 illustrates examples of weight arrangements in a weight matrix of a current image block, according to an exemplary embodiment of the present invention;

FIG. 6 is a view for describing operations of an estimation unit, according to an exemplary embodiment of the present invention;

FIG. 7 is a schematic view of a plurality of image blocks in which motion vectors are estimated using related art block-based motion estimation and the image blocks in which motion vectors are estimated according to an exemplary embodiment of the present invention; and

FIG. 8 shows a photographic image in which motion vectors are estimated using related art block-based motion vector estimation and a photographic image in which motion vectors are estimated according to an exemplary embodiment of the present invention, respectively.

### DETAILED DESCRIPTION OF EXEMPLARY EMBODIMENTS OF THE INVENTION

Hereinafter, the present invention will be described in detail by explaining exemplary embodiments of the invention with reference to the attached drawings.

FIG. 2 is a block diagram of an apparatus for motion vector estimation using motion vectors of neighboring image blocks, according to an exemplary embodiment of the present invention.

Referring to FIG. 2, the apparatus for motion vector estimation using motion vectors of neighboring image blocks includes a block division unit 210, a motion vector estimation unit 220 and a repetition unit 230.

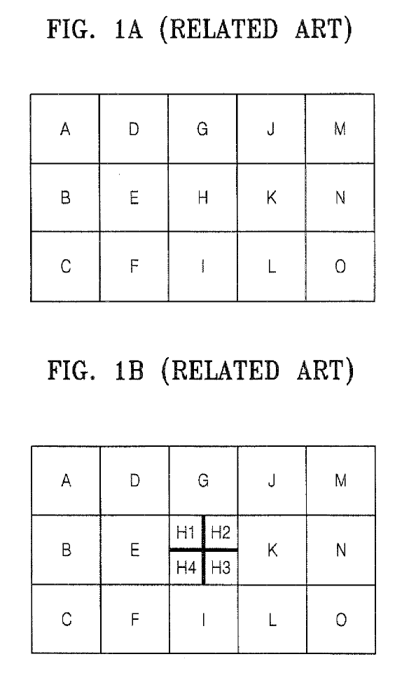

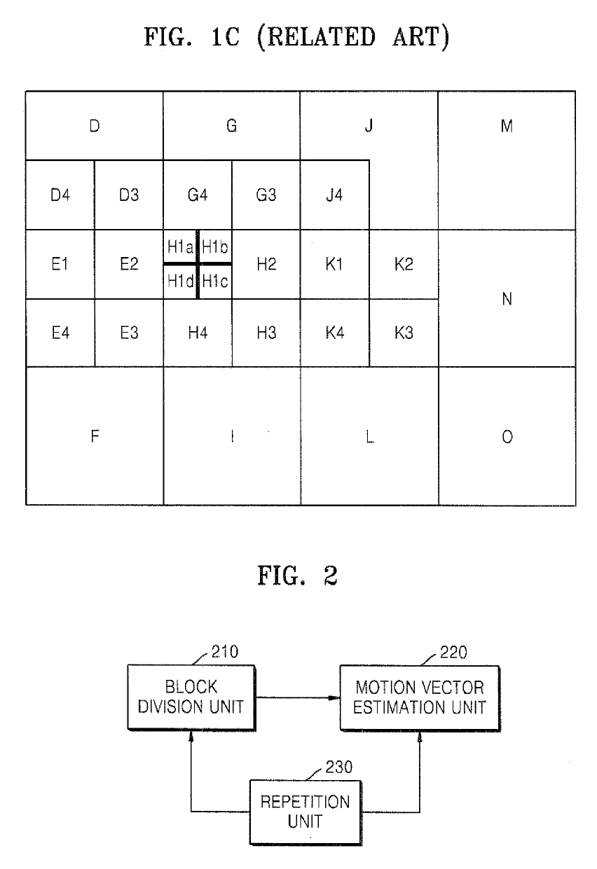

The block division unit 210 divides a current image block into a plurality of sub-blocks in the same manner as the block H of FIG. 1B is divided into the four sub-blocks H1, H2, H3 and H4.

The motion vector estimation unit 220 estimates motion vectors of the sub-blocks using motion vectors and pixel weights of the respective neighboring image blocks. Here, the pixel weights are weights set by pixels of the respective neighboring image blocks.

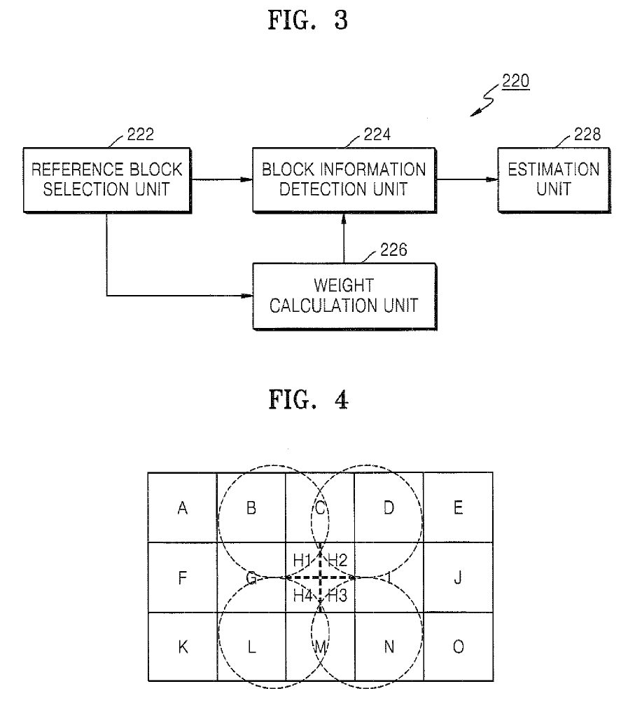

The detailed operations of the motion vector estimation unit 220 will be described later with reference to FIGS. 3 through 8.

The repetition unit 230 detects the number of pixels of the current image block and controls the block division unit 210 and the motion vector estimation unit 220 to repeat their operations until pixel-based motion vectors of the current image block are estimated, based on the number of the pixels of the current image block.

For example, if the current image block includes sixteen pixels, the repetition unit 230 controls the block division unit 210 and the motion vector estimation unit 220 to repeat their operations until the motion vectors for the sixteen pixels of the current image block are estimated.

FIG. 3 is a block diagram of a motion vector estimation unit according to an exemplary embodiment of the present invention.

Referring to FIG. 3, the motion vector estimation unit 220 includes a reference block selection unit 222, a block information detection unit 224, a weight calculation unit 226 and an estimation unit 228.

The reference block selection unit 222 selects one or more reference image blocks, whose motion vectors or weights are to be referred to, from among the neighboring image blocks.

FIG. 4 is a view for describing reference image blocks according to an exemplary embodiment of the present invention.

Referring to FIG. 4, neighboring image blocks of the sub-blocks H1, H2, H3 and H4 are illustrated by circles, respectively. Specifically, the neighboring image blocks of the sub-block H1 are blocks B, C and G, the neighboring image blocks of the sub-block H2 are blocks C, D and I, the neighboring image blocks of the sub-block H3 are blocks I, N and M, and the neighboring image blocks of the sub-block H4 are blocks M, L and G.

For example, the reference image blocks of the sub-block H1 are selected from among the neighboring image blocks B, C and G. Here, all the neighboring image blocks B, C and G can be used as reference image blocks, or just one of the neighboring image blocks B, C and G can be a reference image block.

Referring back to FIG. 3, when the reference image blocks are selected by the reference block selection unit 222, the block information detection unit 224 detects motion vectors and weights of the reference image blocks.

Here, the block information detection unit 224 can detect motion vectors and weights of the current image block as well as the motion vectors and the weights of the reference image blocks.

Also, when the block information detection unit 224 detects the motion vectors, the block information detection unit 224 detects the motion vectors of the reference image blocks or the motion vectors of the current image block in x- and y-directions, and then generates a new motion vector using the motion vectors in the x- and y-directions.

Here, the block information detection unit 224 may obtain the weights of the reference image blocks or the current image block from a lookup table in which the pixel weights of the reference image blocks or the current image block are calculated and stored.

The weight calculation unit 226 calculates the pixel weights of the reference image blocks or the current image block. Specifically, the weight calculation unit 226 calculates the pixel weights to be set and provides the pixel weights to the block information detection unit 224. In this case, the block information detection unit 224 does not refer to the lookup table but uses the pixel weights calculated by the weight calculation unit 226.

However, if the block information detection unit 224 uses the pixel weights obtained from the lookup table, the weight calculation unit 226 can be omitted.

Here, the number of pixel weights of a block corresponds to the number of pixels included in the block. For example, the block including twenty-five pixels has twenty-five pixel weights, which can be represented by a 5×5 matrix.

In the above-described weight matrix, weight arrangements of neighboring image blocks can be determined by the positions of the neighboring image blocks with reference to the position of the current image block. For example, if a neighboring image block is disposed at the top or bottom of the current image block, the weights can be determined to become larger the farther the pixel is from the center of the matrix in a vertical direction. If the neighboring image block is disposed at the left or right side of the current image block, the weights can be determined to become larger the farther the pixel is from the center of the matrix in a horizontal direction. As such, the weights of the neighboring image blocks can be determined. When the pixel-based motion vectors are estimated using the pixel weights, image blocks can be connected smoothly.

However, a weight determination algorithm is not limited to the above method.

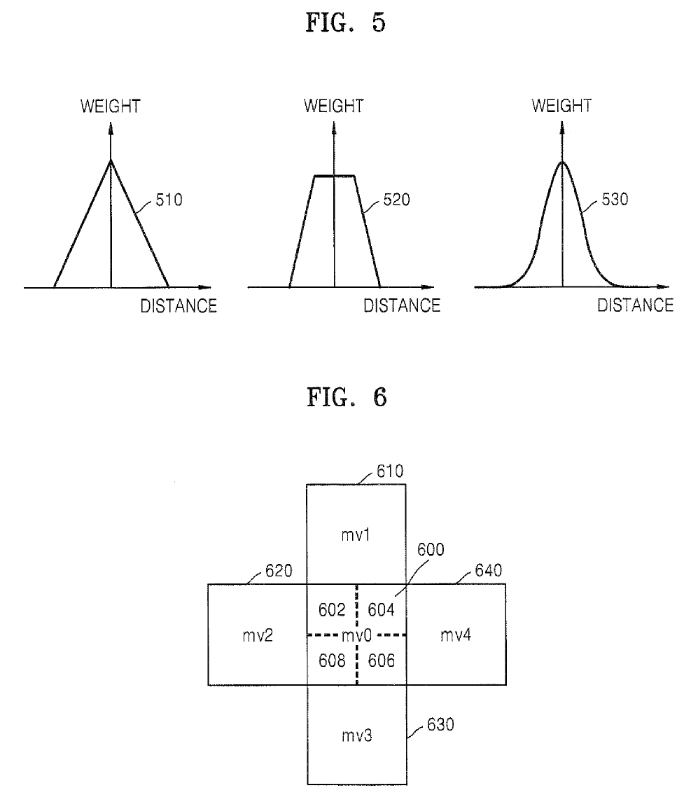

FIG. 5 illustrates examples of weight arrangements in a weight matrix of a current image block, according to an exemplary embodiment of the present invention.

Referring to FIG. 5, a weight arrangement can be a linear type 510, a partially linear type 520 or a non-linear type 530. Here, if the weights of the non-linear type 530 are calculated and used, image blocks can be smoothly connected by estimating motion vectors. However, the estimation requires intensive operation and excessively high hardware costs. On the other hand, if the above-described lookup table is used, the weights do not need to be calculated and thus the motion vector can be estimated using the weights of the non-linear type 530 without problems of cost.

Referring back to FIG. 3, the estimation unit 228 estimates the motion vectors of the sub-blocks using the motion vectors and the pixel weights detected by the block information detection unit 224.

FIG. 6 is a view for describing operations of an estimation unit, according to an exemplary embodiment of the present invention.

Referring to FIG. 6, a current image block 600 and a plurality of reference image blocks 610, 620, 630 and 640 are illustrated. Here, assuming that mv1, mv2, mv3, and mv4 indicate motion vectors of the top reference image block 610, the left reference image block 620, the bottom reference image block 630 and the right reference image block 640, respectively, H0 indicates a weight of the current image block 600, H1 indicates a weight of the top and bottom reference image blocks 610 and 630, and H2 indicates a weight of the left and right reference image blocks 620 and 640, the motion vectors of each of a plurality of sub-blocks 602, 604, 606 and 608 are defined by Equation 3.

M₆₀₂=m0×H0+m1×H1+m2×H2

M₆₀₄=m0×H0+m1×H1+m4×H2

M₆₀₆=m0×H0+m3×H1+m4×H2

M₆₀₈=m0×H0+m1×H1+m2×H2 (3)

For example, pixel-based motion vectors of the sub-block 602 can be estimated by summing a value obtained by multiplying the motion vector mv0 of the current image block 600 by the weight H0 of the current image block 600, a value obtained by multiplying the motion vector mv1 of the top reference image block 610 by the weight H1 of the top reference image block 610, and a value obtained by multiplying the motion vector mv2of the left reference image block 620 by the weight H2 of the left reference image block 620. Thus, motion vectors of all pixels of the sub-block 602 can be calculated by using Equation 3. Likewise, motion vectors of all pixels included in the sub-blocks 604, 606 and 608 can be calculated by using Equation 3.

Here, a value obtained by summing the corresponding pixel weights of H0, H1 and H2 has to be set so as to converge to a predetermined value. For example, the value obtained by summing the weights in the first rows and the first columns of H0, H1 and H2 can be set so as to converge to 1. In this case, when the weights in the first rows and the first columns of H0 and H1 are determined, the weight in the first row and the first column of H2 can be obtained by subtracting a value obtained by summing the weights in the first rows and the first columns of H0 and H1 from 1

Preferably, the estimation unit 228 may include a multiplication unit which multiplies the motion vectors by the weights of each block and an addition unit which sums the motion vectors multiplied by the weights.

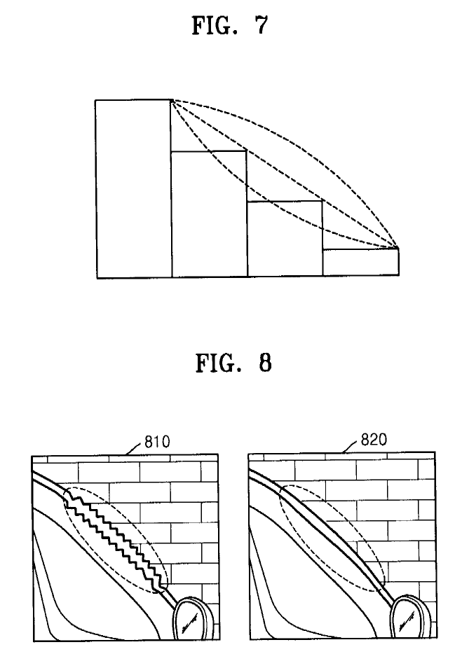

FIG. 7 is a schematic view of a plurality of image blocks in which motion vectors are estimated using related art block-based motion estimation and the image blocks in which motion vectors are estimated according to an exemplary embodiment of the present invention.

Referring to FIG. 7, in the image blocks in which motion vectors are estimated using related art block-based motion estimation, rectangular edges are generated between the image blocks. However, the image blocks in which motion vectors are estimated according to an exemplary embodiment of the present invention are connected smoothly as illustrated by dotted lines. As such, an objective of the present invention, which is to connect a plurality of image blocks smoothly, is achieved.

FIG. 8 shows a photographic image in which motion vectors are estimated using related art block-based motion vector estimation and a photographic image in which motion vectors are estimated according to an exemplary embodiment of the present invention.

Referring to FIG. 8, block artifacts are generated in the left image 810 and the block artifacts are reduced in the right image 820.

When comparing the two images 810 and 820, it can be clearly seen that there are much less block artifacts in the right image 820 than in the left image 810.

The exemplary embodiments of the present invention can be written as computer programs and can be implemented in general-use digital computers that execute the programs using a computer readable recording medium. Examples of the computer readable recording medium include magnetic storage media (e.g., ROMs, floppy disks, hard disks, etc.), and optical recording media (e.g., CD-ROMs, or DVDs).

As described above, according to an exemplary embodiment of the present invention, image blocks can be connected smoothly and block artifacts can be efficiently reduced, by dividing a current image block into a plurality of sub-blocks and then estimating motion vectors of the sub-blocks using motion vectors and pixel weights of a plurality of neighboring image blocks.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of estimating a motion vector using motion vectors of neighboring image blocks, the method comprising:
dividing a current image block into a plurality of sub-blocks; and
estimating motion vectors of the sub-blocks using the motion vectors and pixel weights of the neighboring image blocks adjacent to the sub-blocks.

2. The method of claim 1, further comprising:
detecting a number of pixels of the current image block; and
repeating the dividing of the current image block and the estimating of the motion vectors until pixel-based motion vectors of the current image block are estimated, based on the number of pixels.

3. The method of claim 1, wherein the estimating the motion vectors comprises:
selecting reference image blocks, whose motion vectors and weights are to be referred to, from among the neighboring image blocks;
detecting the motion vectors and the weights of the reference image blocks; and
estimating the motion vectors of the sub-blocks using the motion vectors and the weights of the reference image blocks.

4. The method of claim 3, wherein the estimating the motion vectors further comprises calculating pixel weights of the reference image blocks.

5. The method of claim 3, wherein the detecting the weights of the reference image blocks comprises detecting pixel weights of the reference image blocks from a lookup table in which the pixel weights are calculated and stored.

6. The method of claim 3, wherein the detecting the motion vectors of the reference image blocks comprises:
detecting motion vectors of the reference image blocks in an x-direction; and
detecting motion vectors of the reference image blocks in a y-direction.

7. The method of claim 1, wherein a number of the pixel weights of each of the neighboring image blocks corresponds to a number of pixels of each of the neighboring image blocks.

8. The method of claim 1, wherein the pixel weights of the neighboring image blocks are represented in a matrix, and a weight arrangement of the matrix is determined based on positions of the neighboring image blocks and the current image block.

9. The method of claim 3, wherein the estimating the motion vectors comprises:
multiplying the motion vectors of the reference image blocks by the weights of the reference image blocks;
multiplying the motion vectors of the current image block by pixel weights of the current image block; and
summing the motion vectors of the reference image blocks multiplied by the weights of the reference image blocks and the motion vectors of the current image block multiplied by the pixel weights of the current image block.

10. The method of claim 9, wherein the pixel weights of the current image block are represented in a matrix, and a weight arrangement of the matrix is one of a linear type and a non-linear type.

11. An apparatus for motion vector estimation using motion vectors of neighboring image blocks, the apparatus comprising:
a block division unit which divides a current image block into a plurality of sub-blocks; and
a motion vector estimation unit which estimates motion vectors of the sub-blocks using the motion vectors and pixel weights of the neighboring image blocks adjacent to the sub-blocks.

12. The apparatus of claim 11, further comprising:
a repetition unit which detects a number of pixels of the current image block, and repeats the dividing of the current image block and the estimating of the motion vectors until pixel-based motion vectors of the current image block are estimated, based on the number of pixels.

13. The apparatus of claim 11, wherein the motion vector estimation unit comprises:
a reference block selection unit which selects reference image blocks, whose motion vectors and weights are to be referred to, from among the neighboring image blocks;
a block information detection unit which detects the motion vectors and the weights of the reference image blocks; and
an estimation unit which estimates the motion vectors of the sub-blocks using the motion vectors and the weights of the reference image blocks.

14. The apparatus of claim 13, wherein the motion vector estimation unit further comprises a weight calculation unit which calculates pixel weights of the reference image blocks or of the current image block.

15. The apparatus of claim 13, wherein the block information detection unit detects pixel weights of the reference image blocks from a lookup table in which the pixel weights are calculated and stored.

16. The apparatus of claim 13, wherein the block information detection unit detects motion vectors of the reference image blocks in an x-direction and motion vectors of the reference image blocks in a y-direction.

17. The apparatus of claim 11, wherein a number of the pixel weights of each of the neighboring image blocks corresponds to a number of pixels of each of the neighboring image blocks.

18. The apparatus of claim 11, wherein the pixel weights of the neighboring image blocks are represented in a matrix, and a weight arrangement of the matrix is determined based on positions of the neighboring image blocks and the current image block.

19. The apparatus of claim 13, wherein the estimation unit comprises:
a multiplication unit which multiplies the motion vectors of the reference image blocks by the weights of the reference image blocks and multiplies the motion vectors of the current image block by pixel weights of the current image block; and
an addition unit which sums the motion vectors of the reference image blocks multiplied by the weights of the reference image blocks and the motion vectors of the current image block multiplied by the pixel weights of the current image block.

20. The apparatus of claim 19, wherein the pixel weights of the current image block are represented in a matrix, and a weight arrangement of the matrix is one of a linear type and a non-linear type.

21. A computer readable recording medium having recorded thereon a computer program for executing a method of estimating a motion vector using motion vectors of neighboring image blocks, the method comprising:
dividing a current image block into a plurality of sub-blocks; and
estimating motion vectors of the sub-blocks using the motion vectors and pixel weights of the neighboring image blocks adjacent to the sub-blocks.
